(19) United States
(12) Patent Application Publication
(10) Pub. No.: US 2024/0118531 A1
(43) Pub. Date: Apr. 11, 2024

(54) ENDOSCOPE

(71) Applicant: AMBU A/S, Ballerup (DK)

(72) Inventors: Kaspar Mat MATTHISON-HANSEN, Helsingør (DK); Thomas Bachgaard JENSEN, Værløse (DK)

(73) Assignee: AMBU A/S, Ballerup (DK)

(21) Appl. No.: 18/391,805

(22) Filed: Dec. 21, 2023

Related U.S. Application Data
(63) Continuation-in-part of application No. 18/100,913, filed on Jan. 24, 2023.

(30) Foreign Application Priority Data
Jan. 26, 2022 (EP) 22153394.6
Jan. 19, 2023 (EP) 23152474.5

(51) Int. Cl. G02B 23/24

(52) U.S. Cl. CPC G02B 23/2476; G02B 23/2407

(57) ABSTRACT

A method for providing an insertion cord of an endoscope with graduated flexibility along a length of the insertion cord, the method including providing a main tube having a longitudinal axis, the main tube comprising a coiled core and a polymer layer; raising a temperature of the polymer layer in a portion of the main tube from a first temperature to above a second temperature that is less than a melting point of the polymer layer; bending the portion of the main tube to impose a first meander bend while the temperature is above the second temperature, wherein said bending comprises bending the portion of the main tube at at least two angles relative to a line parallel to the longitudinal axis.

### CROSS-REFERENCE TO RELATED APPLICATIONS

This application is a continuation-in-part of U.S. patent application Ser. No. 18/100,913, filed Jan. 24, 2023, which claims priority from and the benefit of European Patent Application Nos. EP 2215 3394.6, filed Jan. 26, 2022, and EP 2315 2474.5, filed Jan. 19, 2023; said applications are incorporated by reference herein in their entirety.

### TECHNICAL FIELD

The present disclosure relates to an endoscope, more specifically to the main tube used in the manufacture of the insertion cord of an insertion endoscope.

### BACKGROUND

Insertion endoscopes typically comprise a handle at the proximal end to be gripped by an operator and a flexible elongated insertion cord terminated at the distal end in a tip part at the end of a highly bendable, e.g. articulated, bending section, controllable by the operator. The tip part normally comprises a visual inspection means such as a camera, and illumination means such as LED's or exit apertures of light fibers and whatever optics is needed in that connection. Electrical wiring for the camera and other electronics such as the LED lighting run along the inside of the elongated insertion cord from the handle to the tip at the distal end. When, as mentioned, the illumination is instead fiber-optic, the optical fibers run along inside of the elongated insertion cord.

Thus, the controllable bending section is normally an articulated section at the distal tip of the elongated insertion cord that can be controlled by the operator via control knobs arranged on the handle. Typically, this control is effected by tensioning or slacking pull wires also running along the inside of the elongated insertion cord from the tip part to a control mechanism of the handle. Furthermore, a working channel may run along the inside of the elongated insertion cord from the handle to the tip, e.g. allowing liquid to be removed from the body cavity or allowing the insertion of surgical instruments or the like into the body cavity.

Thus, using the controls allows the operator to advance the distal tip of the endoscope to a desired location by means of a series of actions involving, inter alia, bending the bending section in a desired direction, advancing the elongated insertion cord and turning the elongated insertion cord by turning the handle which is rigidly connected thereto. Navigating a tortuous path of bends and turns to a location of interest may subject the elongated insertion cord including the distal controllable bending section to substantial forces including compression, torsion, and bending. The main body of the elongated insertion cord is essentially only bendable enough to follow the direction taken by the bending section. In fact, it could be said that the purpose of the elongated insertion cord is to transmit the longitudinal pushing forces and rotary torsional forces from the handle to the distal end of the elongated insertion cord in order to allow these maneuvers.

The main body of the insertion cord is typically provided as one single tubular member, or main tube, to a distal end of which the bending section is attached, and where the proximal end is connected to the handle. Accordingly, the main tube must be bendable enough to follow the direction taken by the bending section. This, however, does not imply that the insertion cord and, hence, the main tube must have the same rigidity or bendability along the entire length.

Rather, conversely, for many adaptations of an endoscope to a specific purpose, it is desirable to have a varying or graduated bendability or stiffness along the length of the endoscope insertion cord. Typically, the insertion cord is less bendable at the handle, increasingly more bendable towards the distal end and highly bendable at the bending section.

It is well known to provide the main tube as a composite object comprising multiple layers in the wall forming the main tube. Presuming a generally cylindrical main tube, the main tube would comprise concentric layers, often including a wound coil, a braid surrounding the coil and one or more polymer layers ensuring fluid tightness of the main tube wall. The wound coil and the surrounding braid would typically be made of metal, in particular steel.

An approach to graduating the bendability or stiffness of the main tube is disclosed in U.S. Pat. No. 8,734,695, wherein the outer polymer layer surrounding the coil and braid layers is made of a combination of a soft and a rigid polymer resin. The stiffness along a length of the main tube is varied by varying the ratio of the soft and the rigid resin along the length, e.g. by varying the thickness of respective layers of soft and rigid resin, when extruding them onto the coil and braid layers. This co-extrusion of two layers of varying thicknesses or extruding in two steps, unnecessarily complicates the extrusion process.

Similarly, U.S. Pat. No. 7,169,105 suggests to vary the thickness or material properties of various different layers along the length of the main tube in order to achieve a graduated bendability or stiffness along the length thereof.

### BRIEF DESCRIPTION OF THE DISCLOSURE

On this background it is the object of the present disclosure to provide, in a cost-efficient manner, a main tube with graduated bendability for the insertion cord of an endoscope, in particular a disposable i.e. single-use, endoscope that is to be disposed of after use in a procedure on one single patient, rather than being cleaned, disinfected, sterilized etc. and re-used in a new procedure on another patient.

According to a first aspect of the disclosure this object is achieved by a method for making an insertion cord of an endoscope, the method comprising heating a portion of a main tube comprising a metal core and a polymer material surrounding the metal core, said heating placing the polymer material in a softened state, and bending the portion of the main tube while the polymer material is in the softened state. The heating and bending may be referred to as the “conditioning process.”

Subjecting the main tube for the insertion cord to this kind of mechanical and thermal conditioning has been found to influence the bendability of the insertion cord in the desired manner. This conditioning has furthermore been found to persist at least for the necessary duration of the single use of a disposable endoscope. There may be some recovery by the main tube but this may easily be compensated during the conditioning process.

Bending of the portion of the main tube during the conditioning process may be performed in a variety of ways. Said bending can be performed at different angles relative to a longitudinal extent of the main tube, at different angles relative to a transverse extent of the main tube, at different speeds, at different temperatures, at different positions along the main tube, and for different lengths of the portion of the main tube being bent, which may be referred to as the “conditioned main tube portion”.

Said bending may impart different bending characteristics upon the conditioned main tube portion. Said bending may, for example, allow bending of the conditioned main tube portion by application of a force that is smaller than the force required to bend an unconditioned main tube portion, which is a portion of the main tube that has not been subjected to the conditioning process. The unconditioned main tube portion may comprise the same construction as the conditioned main tube portion (e.g. polymer type, layers, cross-section). The unconditioned main tube portion may comprise a different construction, such as a different cross-section shape or circumference).

In one variation, the method comprises providing a portion of a main tube having a longitudinal axis; raising a temperature of the portion of the main tube from a first temperature to above a second temperature; bending the portion of the main tube in a first direction and bending the portion of the main tube in a second direction while the temperature is greater than the second temperature, wherein the bending increases a bendability of the portion of the main tube relative to a bendability of the proximal half of the main tube. A first meander bend is thus imposed which creates the improved bendability. The sum of the angles, in the first and second directions, may comprise an absolute magnitude of less than 30 degrees, meaning that the sum falls within a range between −30 degrees to +30 degrees, preferably +/−20 degrees. The sum of the angles of said bending may equal zero.

In one example, of the present variation, said meander bend comprises two bends and an opposite bend that is opposite the two bends. Each of the two bends is between 80 and 100 degrees and the opposite bend is between 160 and 200 degrees.

The meander bend may be entirely on one plane.

The method may further comprise securing the main tube to a conditioning apparatus comprising a force applicator configured to move from a first position to a second position along a direction not parallel to the longitudinal axis, wherein movement of the force applicator from the first position to the second position causes the first meander bend. The conditioning apparatus may comprise a translatable gripper, and the method may further comprise, securing the main tube to the translatable gripper, and while the main tube is secured to the translatable gripper, translating the translatable gripper to translate the portion of the main tube over the force applicator while the force applicator moves from the first position to the second position. The translatable gripper may comprise a translatable sled with a press to secure the tube to the sled.

The meander bend comprises unbending the main tube portion. Thus, the conditioned main tube portion may be bent more than twice and in the same or different ways to achieve a relatively balanced bendability when the main tube is bent, in use, in different directions. The relatively balanced bendability may be such that the force applied to measure bendability is about the same in one direction as it is in the opposite direction, for the same length and at the same position, of the main tube. In this context, the term “about” means at most +/−20%. Unbending the portion of the main tube comprises bending the main tube at an angle opposite the bending angle and may be referred to as counter-bending the main tube. By opposite it is meant in the opposite direction. In one example, the sum of all the bending and unbending steps equals zero degrees, meaning that an equal amount of bending was performed in each of the two directions, albeit not necessarily with each bending and unbending degree having the same magnitude. The sum may equal less that +/−20 degrees and thus the bending and unbending may be about balanced. When considering whether an angle is for bending or unbending, it is useful to consider which side of the main tube is being bent. If one side of the main tube (radially) contacts a bending apparatus surface upon which the main tube portion bends, and subsequently the opposite side of the main tube contacts the bending apparatus surface, then both sides of the main tube were bent, and one of the two bends is an opposite bend.

In one example of the present variation, the method further comprises, after unbending the portion of the main tube, bending and unbending the portion of the main tube a second time. Said bending and unbending may be complementary. However, the main tube is bent and unbent sequentially, thus the temperature of the main tube may gradually change between said steps and, therefore, the bendability imparted at each bending and unbending step may be slightly different. In FIGS. 5A to 5C bending is performed by the guiding wheels and the push-wheel wheel. The guiding wheels contact one side of the main tube and the push-wheel contacts the opposite side. Thus, the push-wheel unbends (bends the main tube in the opposite way) along a 180 degree arc. The second guiding wheel, following the push-wheel, bends along a 90 degree arc. Thus, the sum of the angles defining the arcs equals zero.

The bending, unbending, and optionally bending/unbending the second time may be continuous. Continuous bending and unbending may be achieved by pulling or pushing the main tube over arcuate supports that bend and/or unbend the main tube as the main tube translates over the arcuate supports. The arcuate supports may comprise surfaces of transverse bars, pulleys, slotted wheels, and any other support with a curved surface.

In one example of the present variation, the polymer material has a first (ambient) temperature before conditioning, and a temperature above a second temperature when the portion of the main tube is bent. As the process imposes the meander bend by bending the tube sequentially, each bend may be imposed at a temperature slightly lower than the previous bend but still higher than the second temperature. These temperatures can be achieved by heating the polymer material before bending the portion of the main tube being conditioned. Because the unbending occurs after the bending, a certain amount of time passes between the bending and the unbending, and during that time the polymer material cools. Preferably the heating is up to but not exceeding the melting point of the polymer material. The high heating temperature will maintain the polymer material in the softened state longer than heating at a lesser temperature. Additional heating may be applied to extend the time that the polymer material on the portion of the main tube being conditioned remains in a softened state. The additional heating should not, however, negate the conditioning effect already imparted onto the main tube.

In an additional example of the present variation, which is preferably combined with the previous example, the main tube is rotated and conditioned again after the rotation. The rotation of the main tube may comprise at least 70 degrees, preferably 80 degrees, and even more preferably at least 90 degrees. Rotation and reconditioning of the main tube imparts graduated flexibility on a different plane from the first conditioning.

In any of the variations and examples of the method according to the first aspect, the main tube may comprise a braid between the metal core and the polymer material. The braid may comprise metal.

In any of the variations and examples of the method according to the first aspect, the polymer material may comprise a single polymer layer or more than one layer. Two or more layers may be co-extruded onto the metal core or the braid.

In any of the variations and examples of the method according to the first aspect, the heating may be inductive or conductive. Heating the metal core has the added advantage of maintaining the polymer material in the softened state for a longer period of time due to more energy being retained in the metal core than in the polymer material and the energy then transferring to the polymer material.

In one variation of the present embodiment, subjecting the main tube to the conditioning process comprises applying heat and a temporary mechanical deformation along at least a part of the length of the main tube between a proximal end and a distal end thereof, wherein the application of heat raises the temperature of the polymer material to soften the polymer material. The magnitude of the temporary mechanical deformation may be varied along the part of the length of the main tube. The polymer material may be heated, for example, to a temperature above half the Vicat temperature but below the melting point of the polymer material.

According to an embodiment of the first aspect of the disclosure, the method comprises providing a main tube as a composite object comprising multiple layers, said multiple layers comprising at least one metal layer and a polymer material, and said main tube having a proximal and a distal end, subjecting the main tube to a conditioning process comprising application of heat and a temporary mechanical deformation along at least a part of the length of the main tube between said proximal end and said distal end, wherein the application of heat raises the temperature of the polymer material to a temperature above the Vicat temperature of the polymer material but below the melting point of the polymer material, and wherein the magnitude of the temporary mechanical deformation is varied along said part of the length of the main tube.

In any of the embodiments, variations and examples of the method according to the first aspect, the heat may be applied locally to the main tube so as to increase the temperature of a sector or section of the main tube during the temporary mechanical deformation of that sector. This has been found to suffice to influence the bendability of the main tube in conjunction with the mechanical deformation.

In any of the embodiments, variations and examples of the method according to the first aspect, the heating is adjusted to raise the average temperature of the polymer material at the temporary mechanical deformation to at least the Vicat softening temperature of the polymer material. This has been found to further improve the conditioning of the main tube.

In one variation of the present embodiment, the heating is adjusted to raise the average temperature of the polymer material at the temporary mechanical deformation to a temperature above the Vicat temperature but below the melting point of the polymer material. Experiments have shown that using a temperature just below the melting point of the polymer and therefore above the Vicat softening point, is efficient in achieving a high effect of the graduation. This has thus been found to even further improve the conditioning of the main tube.

Accordingly, in any of the embodiments, variations and examples of the method according to the first aspect, the heating may be adjusted to raise the average temperature of the polymer material positioned before the temporary mechanical deformation to a temperature above 90% of the melting temperature, preferably above 95% of the melting temperature of the polymer material. This has been found to achieve even better the desired conditioning and bending properties of the main tube.

According to a further embodiment of the first aspect of the disclosure, the temporary mechanical deformation comprises a meander bend in a transverse direction of the main tube. Using a meander bend essentially bends the main tube 90°-180°-90°, the −180° arc being on an opposite side of the 90° arcs, therefore being an opposite bend. These angles need not necessarily be very accurate and it can easily be envisaged that they will deviate, especially when the deflection in the mechanical condition is very small. In any case, it is the intention that the bends thus compensate each other and ensures that the main tube remains substantially straight after the conditioning process. It can be envisioned that two wheels could be aligned in an S-arrangement to provide opposite bending arcs of the same magnitude, which could be greater than 90°. Thus, a meander bend can be provided with two bends.

According to a variation of the present embodiment, the size of the meander bend in the transverse direction of the main tube increases linearly along said part of the length of the main tube from the proximal end towards the distal end of the main tube. This advantageously imparts the main tube with a bendability that increases in a similar, i.e. more of less linear, manner towards the distal end along said part of the length of the main tube conditioned in the process. At the proximal end the transition from initial stiffness to gradually increasing bendability is less of a problem, as this part is less likely to enter the patient. It is also often desirable that only a minor part of the length of the tube is conditioned. In any case, also at the proximal end the unconditioned part could be cut away. Increasing the size of the meander bend means, in the present context, that the distance between the first and last bend increases. Without being bound by theory, it is believed that the increased size increases the cooling time between the first bend (shortly after the heater) and the last bend (furthest away from the heater), and thus the cooling time increases a temperature differential of the portion of the main tube between the first and the last bent, the increased temperature differential resulting in greater flexibility. As discussed below, a piston can be used to increase the size of the meander bend, whereby movement of the piston increases the resulting flexibility proportionally to the distance of travel of the piston.

Accordingly, in some embodiments the part of the length subjected to the conditioning process is at least 15%, preferably at least 25%, and more preferably at least 35% of the length of the main tube between the proximal end and the distal end. The length will, inter alia, depend on the purpose and the nature of the endoscope in which the conditioned main tube is implemented. The conditioned main tube portion is, preferably, located in the distal portion of the main tube, meaning in the distal half of the main tube.

In any of the embodiments, variations and examples of the method according to the first aspect, the main tube comprises steel parts and the heat is applied to the steel parts by electromagnetic induction. This has been found to be a very efficient heating method, which moreover is readily applicable as steel parts such as coils and braids are usually present in main tubes anyway.

According to a further embodiment of the invention, a ceramic heating element is used to irradiate heat towards the main tube. This provides heating irrespective of the magnetic properties of the composite main tube.

According to an embodiment of the first aspect of the disclosure, the main tube is subjected to the conditioning process twice, in particular the main tube is rotated 90° before being subjected to the conditioning process the second time. This 90° rotation need not be very accurately obtained. The main issue is that the conditioning is performed in different directions, and anything in the interval between 70° and 130° would suffice. This imparts the graduated bendability to the main tube in several cross-wise directions, i.e. so that the graduated bendability is not only present in a left-right direction but also in an up-down direction, when looking at a horizontally orientated bending section.

According to a second aspect of the disclosure, the object is also achieved by an endoscope comprising a main tube conditioned using a process according to the first aspect of the disclosure.

According to a third aspect of the disclosure the object is also achieved by a system comprising a display device, and an endoscope according to the second aspect of the disclosure adapted to be connected to the display device.

### BRIEF DESCRIPTION OF THE DRAWINGS

The present disclosure will now be made in greater detail based on non-limiting exemplary embodiment and with reference to the drawings, in which:

FIG. 1 shows a first system comprising a display unit and a first endoscope according to the disclosure connected to the display unit,

FIG. 2 shows a second system comprising the display unit and a second endoscope according to the disclosure connected to the display unit,

FIG. 3 shows an isometric view of a conditioning apparatus adapted to condition the main tube for an endoscope in accordance with the disclosure,

FIG. 4 shows a top plan view of the conditioning apparatus according the FIG. 3,

FIGS. 5A-5C shows details of the conditioning apparatus with the main tube in various stages of the conditioning process,

FIG. 6 shows a cross-section of a section of a main tube applicable in the present disclosure, and

FIG. 7 shows a set-up for measuring a relative value of bending stiffness or bendability.

### DETAILED DESCRIPTION

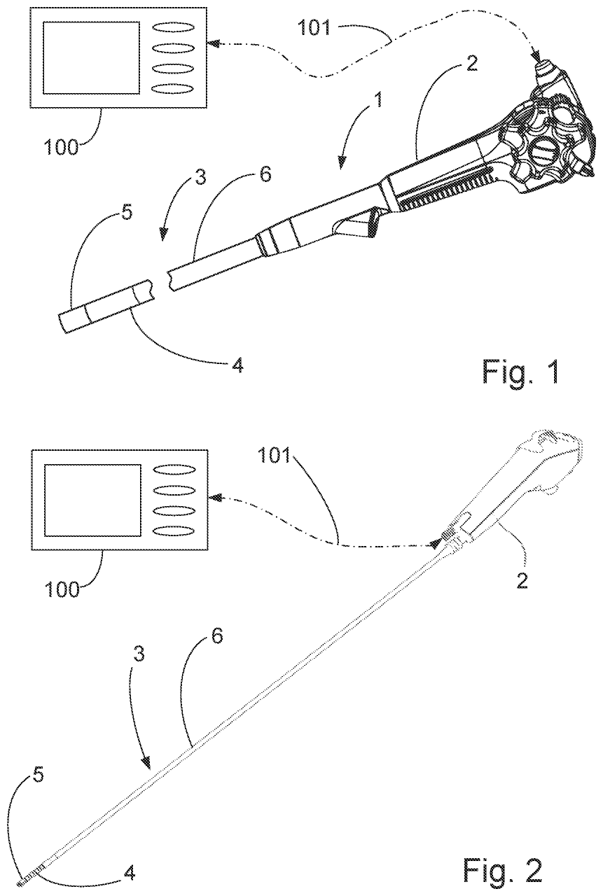

Turning first to FIG. 1, a system comprising an endoscope 1 connectable to a display unit 100 via a cable 101, or other communication means such as wireless communication, is shown. Endoscopes include procedure-specialized endoscopes, for example bronchoscopes, arthroscopes, cystoscopes, ureteroscopes, cholangioscopes, colonoscopes, laparoscopes, gastroscopes, and duodenoscopes. The endoscope 1 shown in FIG. 1 is a duodenoscope. A similar system comprising a different type of endoscope 1, such as a bronchoscope, connectable to a display unit 100, is shown in FIG. 2. The endoscopes 1 are disposable, meaning that they are disposed after use in a single patient and not sterilized or stored for subsequent use, even with the same patient. The display unit 100 can be used multiple times and could be the very same device in FIGS. 1 and 2.

The endoscope 1 comprises a handle 2 and an insertion cord 3 extending from the distal end of the handle. At the distal end the insertion cord 3 terminates in a bending section 4 with a tip housing 5. The insertion cord 3 furthermore comprises a main tube 6, which, in accordance with the disclosure, has been conditioned to achieve a graduated bendability, preferably a bendability that increases along the length of the insertion cord 3 from the handle towards the bending section 4. In FIG. 1 the insertion cord 3 has been shortened for illustration purposes. The insertion cords for duodenoscopes and colonoscopes may be more than a meter long, e.g. 1,250 mm or 1,500 mm. The colonoscope may be 12 mm in diameter. The insertion cords of bronchoscopes are shorter and thinner.

Examination of human cavities with the endoscope 1 may be carried out to determine whether a patient has disease, a tumor, an infection, or the like, and in some cases samples may be taken/removed from the human cavity. For instance, bronchoscopies or colonoscopies may be carried out to examine whether a patient has a lung or colon disease, respectively, a tumor, or the like. The endoscope 1 comprises an image sensor, such as a camera, in the tip housing 5 and connected to the display unit 100 so as to provide the medical personnel with a view of the part of the patient's body being examined. The handle 2 has a steering control lever for maneuvering the tip housing 5 by means of a steering wire or wires.

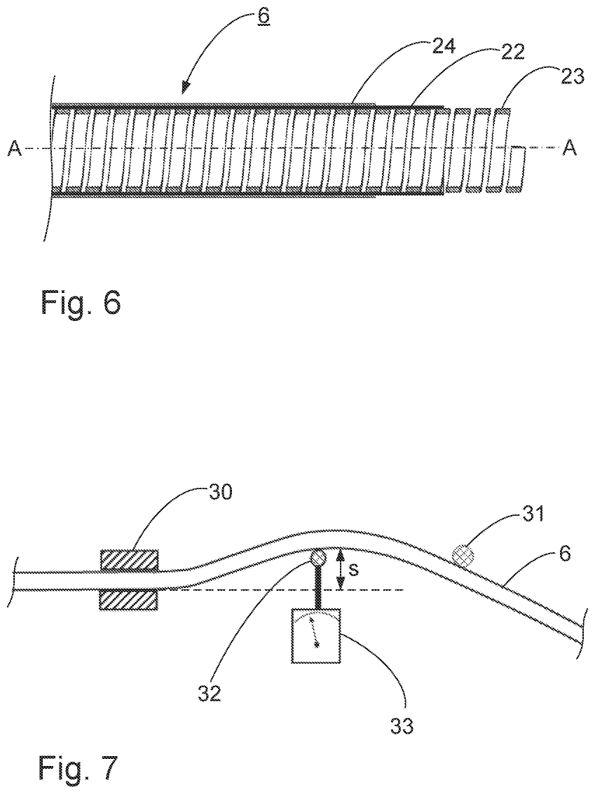

In assembling the endoscope 1, the bending section 4 is connected to the distal end of the main tube 6 and the proximal end of the main tube 6 is connected to the distal end of the handle 2. A section of a typical main tube 6 is shown in cross-section in FIG. 6 with layers partially removed for illustration purposes. A typical main tube 6 that could be used in this disclosure will comprise at least an inner wound coil member 23, preferably made of steel. The inner wound coil member 23 is surrounded by a braid 22, preferably also made of steel. The braid 22 (and the wound coil member), in turn, is covered by a fluid tight layer which is typically extruded onto the coil member 23 and braid 22 assembly. The extruded fluid tight layer is typically a polymer layer 24. The extruded fluid tight layer 24 may comprise a single layer or several polymer layers. Multiple polymer layers may be provided individually or may be provided in a co-extruded multilayer structure. For example, the skin layer of the multilayer polymer layer may provide strength or puncture resistance while an inner layer may be tailored to bond to the braid 22 or to the coil member 23 if a braid 22 is not used. An intermediate layer may be provided to compatibilize the skin and inner layers. The skin layer may also include lubricious additives to facilitate extrusion or navigation of the insertion cord in the patient.

The main tube 8 is subjected to a conditioning treatment in accordance with the present disclosure to provide the desired varying or graduated bendability. The conditioning treatment can be applied to the main tube before or after assembly of the endoscope and before or after attachment of the bending section to the main tube. The conditioning treatment is preferably applied before the main tube is attached to the handle. The graduated bendability can comprise two or more sections with different flexibility, where the flexibility within each section is substantially constant. The graduated bendability can also comprise two or more sections with different flexibility, where the flexibility within at least one of the sections varies, potentially in a continuous manner.

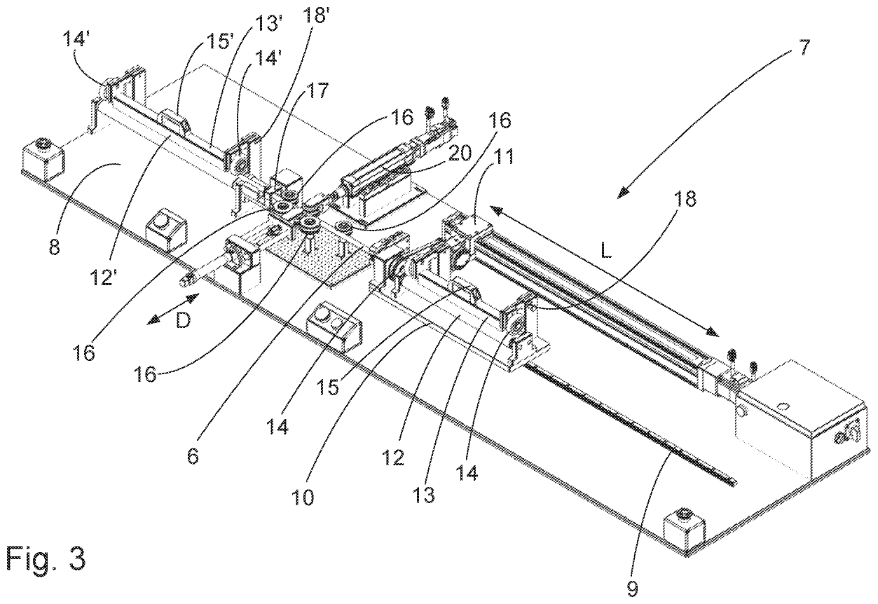

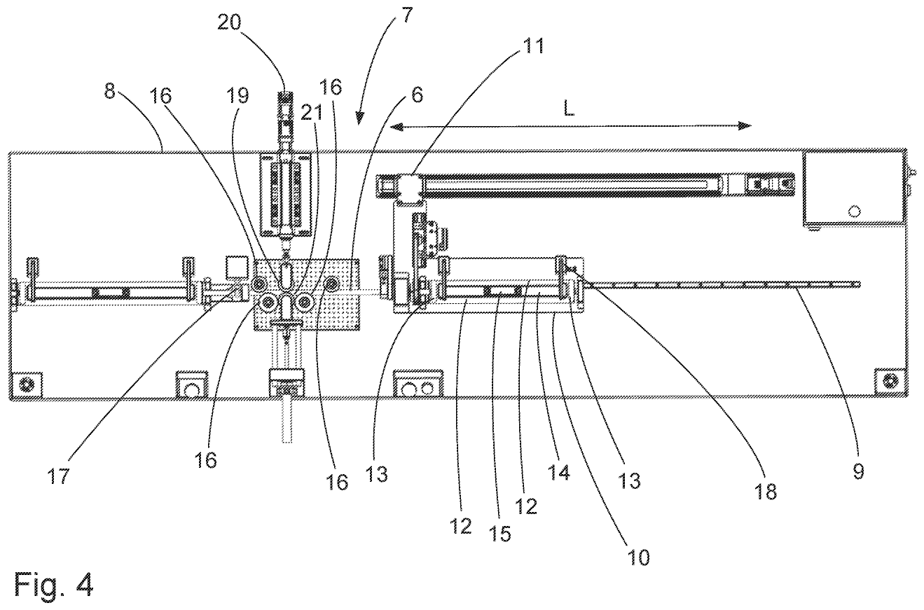

FIGS. 3 and 4 show a main tube 6 placed in a conditioning apparatus 7 adapted to be used in the conditioning according to the disclosure. As will be understood from the description below, the depicted situation is an initial position just before the start of a conditioning run.

In the depicted embodiment the conditioning apparatus 7 comprises a base plate 8, e.g. a table top, a work bench or the like, or a separate base plate 8 to be placed on one of the former. An elongate guide means, or guide, such as a groove in the base plate 8 or a rail 9 provided thereon is provided to guide a sled member, or sled, 10 during a reciprocating movement indicated by the double arrow L. The sled may be referred to as a “translatable gripper” in the sense that the sled has a mechanism to temporarily secure the main tube, or “grip” the main tube, while the sled translates/reciprocates. The mechanism may comprise a clamp secured to the sled, or any arrangement that produces a pinch-point with enough force to hold the main tube as the sled is translated. The reciprocation movement may be effected by a suitable actuator 11, such as a linear actuator. The linear actuator could comprise a linear threaded rod rotated by a gear of an electric motor to effect linear translation. The motor could be a servo motor, a stepper motor, or any motor in which the rotation speed can be controlled by a motor drive. The linear actuator can also be a pneumatic or hydraulic actuator or any other suitable actuator allowing a controlled reciprocating movement of the sled member 10. Pneumatic and hydraulic actuators are operated by controlled fluid pressure, as is known in the art.

The sled 10 comprises a pair of rollers 12 on which the main tube 6 is placed during the conditioning and held down by a guide 13 having a pair of wheels 14 arranged at either end. The guide 13 may comprise additional weight to hold down the main tube 6. To allow the placement of the main tube 6, the guide 13 is arranged on a pair of pivots 18 or hinges, so that it may be swung out of the way using a handle 15.

When the guide 13 is swung out of the way, the main tube may be placed with the part later to constitute the proximal end on the rollers 12 and with the distal end extending from the sled and between a set of guiding pulley wheels 16 or the like forming part of a bending mechanism. The most proximal portion of the main tube 6 that is to be conditioned is placed in close proximity to a heating member 17. In the currently preferred embodiment of the conditioning apparatus the heating member is an induction coil surrounding the main tube and allowing the steel therein to be heated by electrical current provided to the induction coil. Other heating means may or must be used, e.g. if the main tube 6 does not include steel or other material suitable for induction heating. Irradiation with heat from one or more ceramic heating elements arranged suitably around the main tube may be used. Even main tubes without metals, e.g. non-metallic braids or coils, may also be conditioned using the method according to the present disclosure.

For proper holding of the main tube 6, a stationary arrangement corresponding that on the sled 10 may be arranged on the other side of the pulley-wheels 16, e.g. comprising a pair of rollers 12′ on which the main tube 6 is placed during the conditioning and held down by a guide 13′ having a pair of wheels 14′ arranged at either end. This guide 13′ may also incorporate additional weight to hold down the guide 13′ and the main tube 6. To allow the placement of the main tube 6, the guide 13′ is likewise arranged on a pair of pivots 18′ or hinges, so that it may be swung out of the way using a handle 15′.

In conjunction with the set of guiding wheels 16 the bending mechanism comprises a push-wheel 19 arranged in conjunction with a second linear actuator 20 arranged to displace the push-wheel 19 in a transverse direction, i.e. cross-wise to the reciprocating movement of the main tube 6 on the sled 10 but in the same (horizontal) plane, i.e. in a plane parallel to the base plate 8. This allows a transverse force to be applied locally to the main tube 6. A slave wheel 21 or other follower may be arranged opposite the push-wheel 19 on the other side of the main tube 6 and biased against the push-wheel 19 so as to hold and guide the main tube 6 under the pressure of the second actuator 20 and the push-wheel 19.

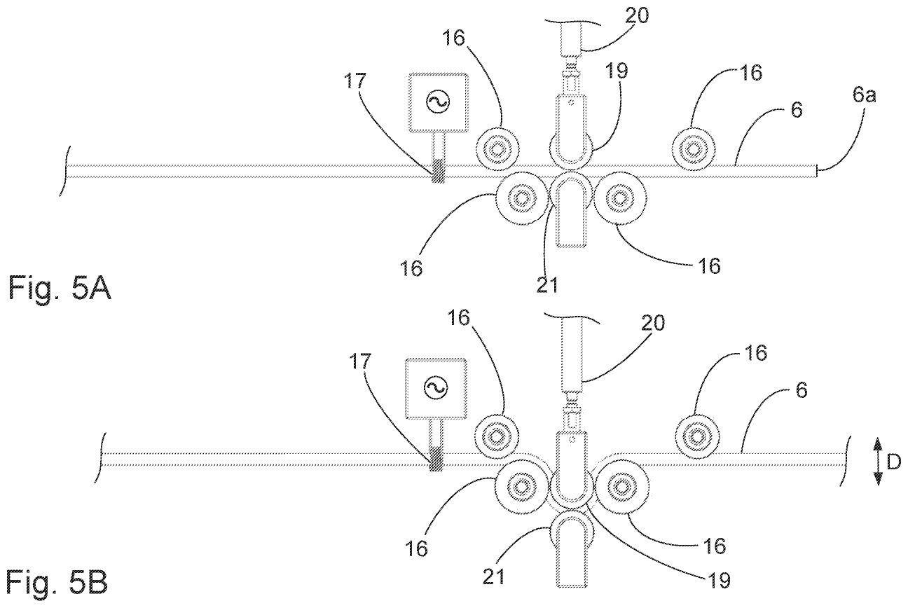

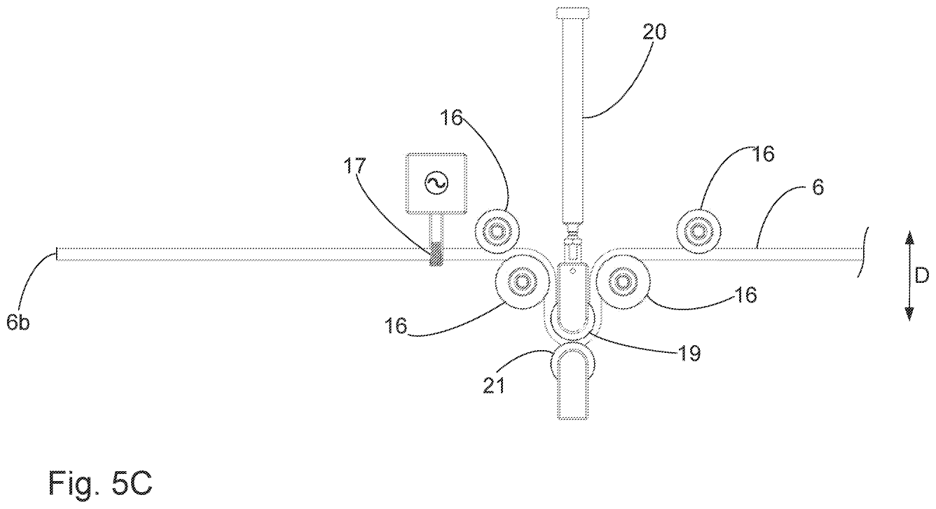

The process of conditioning a main tube 6 using the conditioning apparatus 7 will now be described in conjunction with FIGS. 5A-5C showing the bending mechanism in greater detail.

In FIG. 5C a main tube 6 has been passed through an induction coil providing the heating member 17 and between the pulley-wheels 16 as well as the push-wheel 19 and the slave wheel 21. No force or heating is applied to the main tube 6 yet and it is therefore in the straight as-made condition, i.e. cylindrical around a longitudinal axis A-A, as shown in FIG. 6. The proximal end 6a of the main tube 6 at the right-hand side of FIG. 5A is located and held on the sled 10 (shown in FIGS. 3 and 4). In FIG. 5C the distal end 6b of the main tube 6 is seen on the left-hand side.

When the conditioning starts, alternating current is supplied to the induction coil which generates eddy currents in the steel parts of the main tube 6, such as the braid 22 or the coil 23, cf. FIG. 6. This, in turn, heats up the outer polymer layer 24 covering the braid 22. At the same time the sled 10 starts pulling the main tube 6 though the induction coil of the heating member 17 towards the right-hand side of FIG. 5A, so that heating will be applied locally over a short length of the main tube 6 as it is moved through the induction coil of the heating member 17. In this respect it should be noted that the use of an induction coil is only one way of heating, irradiation or heat transfer from a heated fluid could also be used.

As the first actuator 11 pulls the sled 10 and thus the main tube 6 to the right-hand side in FIGS. 5A-5C, the second actuator 20 moves the push-wheel 19 in a cross-wise direction, as indicated with the double arrow D, to bend the main tube around the push-wheel 19 and at least some of the pulley-wheels 16, preferably in a meander bend as shown in FIGS. 5B and 5C. This happens while the local heating of the main tube 6 is still present, so that the meander bend of the main tube 6 is hot. The most proximal portion of the main tube 6 that is to be conditioned reaches the push-wheel 19 first, with other portions following. As the push-wheel 19 translates further, the amount of conditioning increases. If the push-wheel 19 translates in a continuous manner, whether at a constant or variable speed, the conditioning will also be continuous albeit graduated or variable based on the movement of the push-wheel 19.

By comparison between FIGS. 5B and 5C it can be understood that for this embodiment the stroke of the second actuator 20 increases while the main tube 6 is pulled through the pulley-wheels 16 so that the size of the meander bend imparted to the main tube 6 increases towards the distal end of the main tube 6. This continues until eventually the distal end reaches the pulley-wheels 16. At this stage it is preferred to stop the pulling of the main tube 6, stop supplying current to the heating member, and return the push-wheel 19 to the original neutral position, i.e. as shown in FIG. 5A.

The lateral deflection need not be performed as a smooth sliding motion by the actuator 20. Embodiments where the conditioning process is applied more step-wise are also part of the disclosure. E.g. the actuator 20 could maintain the same stroke to give the same deflection for one section of the length of the main tube 6 being conditioned, then the actuator 20 is moved momentarily to a new stroke where another sector of the length of the main tube 6 is conditioned and so on.

The speed at which the main tube 6 passes through or by the heating member 17 can also be varied. In one variation of the present embodiment, the main tube 6 is translated by the sled at a speed that decreases from an initial speed. In one example, the speed decreases at a rate of about 1 mm/sec. The initial speed may be about 15 mm/sec. In another example, the speed decreases at a first rate for a portion to be conditioned, then the speed decreases at a second, faster, rate for the next portion to be conditioned, and finally the speed increases at a third rate for a third portion to be conditioned. The absolute magnitude of the second and third rates might be the same. The second rate may be 2-3 times the first rate. In one specific example, the first rate is about −1 mm/sec, indicating a speed decrease, the second rate is about −2.5 mm/sec, and the third rate is 2.5 mm/sec. The first portion maybe 20 cm long, the second portion may be 20 cm long, and the third portion may be 30 cm long. Of course the portions could have the same length or different lengths. The transition from one rate to the next is, preferably, made gradually.

The distance from the heating member 17 to the center of the push-wheel 19 when the center of the push-wheel 19 is aligned with the main-tube 6/heating member 17 can be between 60 and 120 mm, preferably between 80 and 110 mm. The smaller end of the range is to account for the diameter of the wheel 16 between the heating member 17 and the push-wheel 19 and also the diameter of the push-wheel 19. The wheels 16 that bend/unbend the main tube 6 may comprise inner diameters of about 35-60 mm, preferably between about 40-50 mm. The push-wheel 19 may comprise an inner diameter of about 25-50 mm, preferably between about 30-40 mm. The push-wheel 19 may travel in the order of 40 mm to create the meander bend. Of course these values are one example for one type of tube and are demonstrated to condition the main tube 6 without damaging or causing permanent deformation of the core of the main tube 6, which in this case may be in the range of 8-16 mm in diameter.

With the push-wheel in the neutral position the first actuator 11 may push the sled 10 and the main tube back to the original position.

From here the wheels 13 and/or the rollers 12 may be used to rotate the main tube 6 by 90°, upon which the process of propagating the meander bend as a wave along the main tube 6 described above may be repeated to achieve a conditioning in the orthogonal direction. The rotation by 90° could of course also be achieved by other means, e.g. by gripping and turning the main tube manually. Further conditioning, e.g. turning a further 90° (twice) to effect conditioning in the opposite directions has been found not to be necessary, but would of course be possible, as would angles in between.

Rather than controlling the push-wheel 19 using an electrical, pneumatic or hydraulic linear actuator, the push-wheel 19 could be moved mechanically. That is to say, be part of a cam follower in the bending mechanism. The cam itself would extend along the main tube 6 in a fixed relation thereto, allowing a linear motion of the bending mechanism along the length of the main tube 6 to be converted into a lateral pushing motion dependent on the shape of the cam. A straight wedge-shaped cam would thus provide a constant linear increase in deflection, when moving the bending section along the main tube 6. A cam with a specific curvature could also be used to impart specific bending properties. Needless to say that the electrical, pneumatic or hydraulic linear actuator could also be controlled in a non-linear manner to impart specific bending properties. The skilled person will be able to devise many different setups to achieve the mechanical conditioning, including multiple meanders, and coiling i.e. bends of more than 360°, without departing from the disclosure and the scope of the claims.

The maximum degree of mechanical deflection imparted will depend on the dimensions of the main tube, i.e. diameter and overall length as well as the procedures the endoscope is designed for.

FIG. 7 shows a set-up for measuring a relative value for the bending stiffness or bendability. A main tube 6 is arranged in a fixture 30 providing a fixed clamping. A support roller 31 is used for limiting the movement of the main tube, while a pressure roller 32 is pressed against the main tube 6. The force necessary to bend the main tube a preselected distance s, can be used as a measure for the bendability or stiffness. This force is measured by a force meter 33. The distance s as well as the distance between the fixture 30 and the support roller 31 are selected in relation to the diameter of the main tube 6. For an outer diameter of the main tube 6 in the range 10-12 mm, it has been found that a distance between fixture 30 and support roller of 150-200 mm, and a distance s in the range 10-30 mm works well. The same distances are applied when measuring at different points along the main tube 6. The distance between fixture 30 and support roller 31 will define the minimum distance from the distal end 6b and the proximal end 6a, respectively, in which it will be possible to measure. The distance s may be, for example, 10 mm, 20 mm, 30 mm. The force measurement may be performed at various distances and the results may be averaged.

If the conditioned main tube portion comprises different degrees of conditioning, an average may be computed by moving the main tube through the fixture and averaging force values obtained at different distances from the distal edge of the main tube. Alternatively, the degree of conditioning may be based on the maximum amount of bendability measured, which will typically be at the most distal conditioned portion.

Because different tests can be used to determine bendability, it is preferred to refer to bendability in the context of the improvement over the unconditioned main tube portion. The improvement, as a ratio of the force measured in the conditioned and unconditioned main tube portions, may be valuable if at least 25%, 50%, 75%, 100%, 150%, and 200%.

It has been found that a main tube 6 of a colonoscope having up to approximately double the bendability towards the distal end 6b compared to the part at the proximal end 6a, often works well during an endoscopic procedure. Such a main tube 6, with twice the bendability at the most distal conditioned portion than at the unconditioned portion, has been produced using the conditioning apparatus according to the method described herein. Of course, less conditioning is also possible using the same methodology and more may be possible depending on the constitution and characteristics of the main tube, e.g. diameter and core material.

Often, the bendability at the proximal end 6a would be the bendability of the main tube 6 without being subjected to the conditioning process described in this disclosure. So, the main tube 6 is preferably designed to have this bendability when manufactured. The exact parameters for the conditioning process can then be defined by use of the set-up in FIG. 7, e.g., by trial-and-error testing, where the force for bending the main tube 6 the distance s in FIG. 7 is a relative measure for the bendability. To double the bendability, the force should be reduced to half the value.

There may be a linear change of bendability from the proximal end 6a the distal end. But often other functional relationships for the change in bendability are preferred. This could be more stepwise changes, or changes of a second order nature (e.g., the bendability increases with the distance from the proximal end squared). It should be noted that often only a minor part of the main tube needs the increased bendability towards the distal end. For example, for some endoscopes only 40% or less, or 30% or less, of the main tube length needs the conditioning treatment. The conditioned part of the main tube is generally located towards the distal end, preferably in the distal half of the main tube.

In relation to the temperature to be applied for the main tube 6 during the conditioning process, it has been found that heating the main tube 6 to a temperature which is at or above the Vicat softening temperature, which can be determined by the standards ASTM D1525 or ISO 306, of the polymer and which is below the melting temperature of the polymer applied, will give the best result. The ASTM D1525 or ISO 306 test methods determine the Vicat softening temperature of the material. The general method includes four species, whereby the applied load can be 10 N for the Vicat A test method or 50 N for the Vicat B test method. The Vicat A test method can be performed at heating rates of 50 or 120° C./h. The four species are thus referred to as A50, B50, A120, and B120. The test methods yield similar results and may be used for different materials or for convenience. Unless stated otherwise herein, the Vicat values referenced in the present application refer to values obtainable with the Vicat test method A120 and temperature values are in the Celsius scale. This temperature should at least on average be the temperature of the polymer layer at the time the temporary mechanical deformation is applied. That is to say, in the embodiment of FIGS. 5B and 5B, throughout the meander bend.

It is preferable to use a temperature below but close to the melting temperature of the polymer material, preferably above 90% or even 95% of the melting temperature, i.e. above approximately 164° C. or above 173° C. for a polymer material having a melting point of 182° C., such as Pellethane®.

However, suitable conditioning can also be achieved at lower temperatures. Even at an average temperature around half of the Vicat softening temperature for the polymer a graduated bendability can be achieved. The lower temperature may be compensated by a more intense mechanical treatment. Variables that increase the intensity of the mechanical treatment include the speed at which the treatment is applied, the bending angles, the number of bends, and the distances between the bends.

Alternatively, the temperature at which softening occurs may be at or above 25%, 40%, 50%, 60%, 70%, and 75% of the melting point of the material but below the melting point. The Vicat softening point can be, for example, about 50% of the melting point. Thus, at 25% of the melting point, corresponding to ½ the Vicat softening point, the material is not as softened as at 50%, and this affects the force required to apply the mechanical deformation of the conditioning process and the aesthetic result on the surface of the main tube. In theory, the mechanical deformation can be applied at room temperature, without softening. However, it has been found that even a small amount of softening results in a more aesthetically pleasing product. Thus, even at 25% of the melting point, a desirable product may be manufactured.

In case one or more different polymers are applied for the main tube 6, e.g. a multilayer polymer structure or a polymer blend, the temperature for the conditioning process should preferably be above the highest Vicat softening temperature, and below the lowest melting temperature, among the different polymers in the blend or multilayer polymer structure. However, when there is a main polymer and small amounts of other polymers, the other polymers may be considered additives and the melting temperature of the main polymer may be used as the polymer melting temperature. For example, if the polymer blend comprises at least 60% of one polymer, the melting point of that polymer may be used as the melting temperature.

There will often be a temperature gradient in the polymer material 24. To reduce the risk that parts of the polymer 24 have a temperature outside of the suggested range during the conditioning process, a target temperature for the heating could be selected in the middle of this range. For the inductive heating given as example, the temperature will tend to be highest in and close to steel parts of the main tube (i.e., braiding 22 and coil 23), and lowest on the outer polymer surface. For other types of heating the temperature profile may be different.

It has been found that polymer materials of the types thermoplastic elastomer (TPE) and thermoplastic polyurethane (TPU) works well with the disclosed method. But also other polymer types can be applied. One example of polymer for the main tube is Pellethane® (a medical grade thermoplastic polyurethane elastomer) having a Vicat softening temperature of 81° C. and a melting point at 182° C. (in this example, the Vicat softening temperature is 45% of the melting point).

The following items are further variations and examples of the embodiments described with reference to FIGS. 1 to 7.
1. A method for providing an insertion cord of an endoscope with graduated flexibility along the length of the insertion cord, the method comprising providing a main tube as a composite object comprising multiple layers, said multiple layers comprising at least one metal layer and a polymer material, and said main tube having a proximal and a distal end, subjecting the main tube to a conditioning process comprising application of heat and a temporary mechanical deformation along at least a part of the length of the main tube between said proximal end and said distal end, characterized in that the application of heat raises the temperature of the polymer material to a temperature above the Vicat temperature of the polymer material but below the melting point of the polymer material, and wherein the magnitude of the temporary mechanical deformation is varied along said part of the length of the main tube.
2. A method according to item 1, wherein the heat is applied to the main tube so as to increase the temperature of a sector of the main tube prior to the application of the temporary mechanical deformation of that sector.
3. A method according to item 2, wherein the temperature of the sector at the time the application of the temporary mechanical deformation is applied is above half of the Vicat temperature.
4. A method according to item 2, wherein the temperature of the sector at the time the application of the temporary mechanical deformation is applied is above the Vicat temperature.
5. A method according to item 1, where the heat is applied locally to the main tube so as to increase the temperature of a sector of the main tube during the temporary mechanical deformation of that sector.
6. A method according to any one of the preceding items, wherein the heating is adjusted to raise the average temperature of the polymer material at the temporary mechanical deformation to at least the Vicat softening temperature of the polymer material.
7. The method according to item 6, wherein the heating is adjusted to raise the average temperature of the polymer material at the temporary mechanical deformation to a temperature above the Vicat temperature but below the melting point of the polymer material.
8. The method according to item 7, wherein the heating is adjusted to raise the average temperature of the polymer material at the temporary mechanical deformation to a temperature above 90% of the melting temperature, preferably above 95% of the melting temperature of the polymer material.
9. A method according to any one of the preceding items, wherein the temporary mechanical deformation comprises a meander bend in a transverse direction of the main tube.
10. A method according to item 9, wherein the size of the meander bend in the transverse direction of the main tube increases linearly along said part of the length of the main tube from the proximal end towards the distal end of the main tube.
11. A method according to any one of the preceding items, wherein the temporary mechanical deformation comprises first meander bend in a transverse direction of the main tube and a second meander bend in the transverse direction of the main tube.
12. A method according to item 11, wherein the size of the first meander bend is less than the size of the second meander bend, wherein the second meander bend is distal of the first meander bend.
13. A method according to any one of items 9 to 12, wherein the part of the length subjected to the conditioning process is at least 15%, preferably at least 25%, and more preferably at least 35% of the length of the main tube between the proximal end and the distal end.
14. A method according to item 13, wherein the main tube part has a proximal portion extending from the handle to 50% of the length of the main tube and a distal portion extending from the proximal portion and comprising the remaining 50% of the length of the main tube, and wherein the part of the length subjected to the conditioning process is in the distal portion of the main tube.
15. A method according to any one of the preceding items, wherein the metal layer of the main tube comprises steel and the heat is applied to the steel by electro-magnetic induction.
16. A method according to any one of the preceding items, wherein a ceramic heating element is used to irradiate heat towards the main tube.
17. A method according to any one of the preceding items, wherein the main tube is subjected to the conditioning process a first time and, after the first time, a second time.
18. A method according to item 17, wherein the main tube is rotated after the first time before being subjected to the conditioning process the second time.
19. A method according to item 18, wherein the main tube is rotated, after the first time and before the second time, about an angle in the interval between 70° and 130°, preferably 90°.
20. An endoscope comprising a main tube conditioned using a process according to any one of the preceding items.
21. A method for providing an insertion cord of an endoscope with graduated flexibility along the length of the insertion cord, the method comprising: providing a main tube having a proximal end and a distal end, the main tube comprising a coil enclosed in a polymer material, and subjecting the main tube to a conditioning process comprising application of heat and a temporary mechanical deformation along at least a portion of the main tube, the temporary mechanical deformation being applied while the temperature of the polymer material of the portion of the main tube is above 50% of the Vicat temperature of the polymer material but below the melting point of the polymer material.
22. The method of item 21, wherein the temporary mechanical deformation is applied while the temperature of the polymer material of the portion of the main tube is above the Vicat temperature of the polymer material.
23. The method of items 21 and/or 22, wherein the portion of the main tube is at most 50% of a length of the main tube.
24. The method of item 23, wherein the main tube has a proximal portion extending from the handle to 50% of the length of the main tube and a distal portion extending from the proximal portion and comprising the remaining 50% of the length of the main tube, and wherein the portion of the main tube subjected to the conditioning process is in the distal portion of the main tube.
25. The method of any one of items 21-24, wherein a magnitude of the temporary mechanical deformation is varied.
26. The method of item 25, wherein the magnitude is varied continuously.
27. The method of item 25, wherein the magnitude is varied step-wise.
28. The method of any one of items 21-27, wherein the temporary mechanical deformation comprises a first bend and a first counter-bend.
29. The method of item 28, wherein the temporary mechanical deformation comprises, after the first bend and the first counter-bend, a second bend and a second counter-bend, the total amount of bending and counter-bending being complementary should that the main tube, after application of the temporary mechanical deformation, is straight.
30. The method of item 29, wherein the first bend and the first counter-bend comprise a meander bend in a transverse direction of the main tube.
31. The method of item 30, wherein the meander bend further comprises the second bend and the second counter-bend.
32. The method of items 30 or 31, wherein the size of the meander bend in the transverse direction of the main tube increases linearly from the proximal end towards the distal end of the main tube.
33. The method of item 32, wherein the portion of the main tube subjected to the conditioning process is at least 15%, preferably at least 25%, and more preferably at least 35% of the length of the main tube.
34. The method of any one of items 21-33, wherein the size of the first meander bend is less than the size of the second meander bend, wherein the second meander bend is distal of the first meander bend.
35. The method of any one of items 21-33, wherein the main tube has a proximal portion extending from the handle to 50% of the length of the main tube and a distal portion extending from the proximal portion and comprising the remaining 50% of the length of the main tube, and wherein the portion subjected to the conditioning process is in the distal portion of the main tube.
36. The method of any one of items 21-35, further comprising rotating the main tube after applying the conditioning process the first time, and subjecting the portion of the main tube to the conditioning process a second time.
37. The method of item 36, wherein rotating the main tube comprises rotating the tube about an angle in the interval between 70° and 130°, preferably about 90°.
38. The method of item 37, wherein subjecting the portion of the main tube to the conditioning process a second time comprises subjecting the portion of the main tube to the same conditioning process, albeit after rotating the main tube.
39. The method of item 37, wherein subjecting the portion of the main tube to the conditioning process a second time comprises subjecting the portion of the main tube to a different conditioning process, albeit after rotating the main tube, the different conditioning process comprising at least one of a different temperature, processing speed, and/and angle magnitude than the first conditioning process, the second conditioning process imparting a different bendability than the first conditioning process.
40. The method of any one of items 21-39, wherein the coil comprises steel and the heat is applied to the steel by electromagnetic induction.
41. The method of any one of items 21-40, wherein the main tube further comprises a braid between the coil and the polymer material.
42. The method of any one of items 21-41, wherein the polymer material comprises a co-extruded polymer structure.
43. The method of any one of items 21-41, wherein the polymer material comprises a blend of polymers.
44. The method of any one of items 21-43, wherein the heating is adjusted to raise the average temperature of the polymer material at the temporary mechanical deformation to a temperature above 90% of the melting temperature, preferably above 95% of the melting temperature of the polymer material.
45. The method of any one of items 1-19 or 21-44, wherein the heating is adjusted to raise the average temperature of the polymer material at the temporary mechanical deformation to a temperature above 25% of the melting temperature, preferably above 50% of the melting temperature of the polymer material.
46. The method of any one of items 1-19 or 21-44, wherein the thickness of the polymer material is constant.
47. The method of any one of items 1-19 or 21-44, wherein during extrusion of the polymer material onto the core of the main tube, the core is translated at varying speeds to vary the thickness of the polymer material.
48. An endoscope comprising a main tube conditioned using a process according to any one of items 21-47.
49. A system comprising a display device, and an endoscope according to items 20 or 48, the endoscope being adapted to be connected to the display device.
50. A conditioning apparatus configured to implement a method according to any one of items 1-19 and 21-47, the conditioning apparatus comprising: a heater, a sled, a first wheel, a second wheel, and a third wheel, the sled configured to translate in a longitudinal direction, the heater configured to heat a portion of a main tube to be mechanically conditioned, the main tube comprising a coil enclosed in a polymer material, the third wheel positioned between the first wheel and the second wheel and configured to translate at a non-zero angle relative to the longitudinal direction, the sled configured to pull the main tube away from the heater to cause the portion of the main tube to bend and counter-bend between the first, second and third wheels while a temperature of the portion of the main tube is above 50% of the Vicat temperature but below the melting point of the polymer material.
51. The conditioning apparatus of item 50, further comprising a linear actuator configured to translate the second wheel.
52. The conditioning apparatus of item 48, wherein the linear actuator is configured to translate the second wheel in a continuous manner.

We claim:

1. A method for providing an insertion cord of an endoscope with graduated flexibility along a length of the insertion cord, the method comprising:
providing a main tube having a longitudinal axis, the main tube comprising a coiled core and a polymer layer;
raising a temperature of the polymer layer in a portion of the main tube from a first temperature to above a second temperature that is less than a melting point of the polymer layer;
bending the portion of the main tube to impose a first meander bend while the temperature is above the second temperature,
wherein said bending comprises bending the portion of the main tube at at least two angles relative to a line parallel to the longitudinal axis,
wherein a sum of the angles comprises an absolute magnitude of less than 30 degrees, and
wherein the bending increases a bendability of the portion of the main tube relative to a bendability of the proximal half of the main tube.

2. The method of claim 1, wherein the sum of the angles comprise an absolute magnitude of less than 20 degrees.

3. The method of claim 4, wherein the sum comprises an absolute magnitude of less than 10 degrees.

4. The method of claim 1, wherein the first meander bend is entirely on a first plane.

5. The method of claim 1, wherein the first meander bend comprises two bends and an opposite bend that is opposite the two bends.

6. The method of claim 5, wherein each of the two bends is between 80 and 100 degrees and the opposite bend is between 160 and 200 degrees.

7. The method of claim 1, the method further comprising securing the main tube to a conditioning apparatus comprising a force applicator configured to move from a first position to a second position along a direction not parallel to the longitudinal axis, wherein movement of the force applicator from the first position to the second position causes the first meander bend.

8. The method of claim 7, wherein the conditioning apparatus comprises a translatable gripper, and wherein the method further comprises, securing the main tube to the translatable gripper, and while the main tube is secured to the translatable gripper, translating the translatable gripper to translate the portion of the main tube over the force applicator while the force applicator moves from the first position to the second position.

9. The method of claim 7, wherein the conditioning apparatus comprises a translatable gripper, and wherein the method further comprises, securing the main tube to the translatable gripper, and while the main tube is secured to the translatable gripper, causing movement of the force applicator from the first position to the second position.

10. The method of claim 1, the method further comprising, after providing the first meander bend, rotating the main tube and imposing a second meander bend onto the portion of the main tube, the second meander bend being on a second plane different than the first plane.

11. The method of claim 10, wherein rotating the main tube comprises rotating the main tube at an angle between 70° and 130°.

12. The method of claim 1, the method further comprising:
securing the main tube to a conditioning apparatus comprising a force applicator and a translatable gripper, the force applicator configured to move from a first position to a second position along a direction not parallel to the longitudinal axis, and the translatable gripper configured to translate the main tube over the force applicator;
causing the force applicator to move from the first position to the second position; and
simultaneously causing the translatable gripper to translate the main tube while the force applicator moves from the first position to the second position,
wherein movement of the force applicator from the first position to the second position and simultaneous translation of the main tube form the first meander bend along the first plane.

13. The method of claim 12, the method further comprising imposing a second meander bend on a second plane different than the first plane.

14. The method of claim 1, the method further comprising:
bending the portion of the main tube from a first position to a second position along a direction not parallel to the longitudinal axis; and
simultaneously with said bending, translating the main tube,
wherein said stretching and translating form the first meander bend along the first plane.

15. The method of claim 14, wherein the movement of the force applicator from the first position to the second position causes a variable deformation of the portion of the distal half of the main tube in a variable manner.

16. The method of claim 15, wherein the variable deformation is continuous and increases distally.

17. The method of claim 1, wherein the second temperature is 50% of the Vicat softening point of the polymer material.

18. The method of claim 1, wherein said raising of the temperature and said bending comprise a conditioning process, wherein the portion of the main tube subjected to the conditioning process is at least 25% of a length of the main tube.

19. The method of claim 18, wherein the portion of the main tube subjected to the conditioning process is at least 35% of the length of the main tube and is positioned distally of a middle point of the main tube,

20. An endoscope comprising a main tube conditioned according to the method of claim 1.

21. A system comprising:
a display device; and
an endoscope according to claim 19, the endoscope being configured to be connected to the display device.
